(19) United States
(12) Patent Application Publication
(10) Pub. No.: US 2009/0300936 A1
(43) Pub. Date: Dec. 10, 2009

(54) Spin Drying Method

(76) Inventors: Jae-Mun Kim, Gyungsangnam-do (KR); Sang-Tae Byun, Busan (KR); Gi-Hyeong Do, Gyungsangnam-do (KR)

Correspondence Address: MCKENNA LONG & ALDRIDGE LLP, 1900 K STREET, NW, WASHINGTON, DC, 20006, US

(21) Appl. No.: 12/226,002

(22) PCT Filed: Apr. 5, 2007
(86) PCT No.: PCT/KR2007/001676

§ 371 Date: Jul. 21, 2009

(30) Foreign Application Priority Data
Apr. 5, 2006 (KR) 10-2006-0031149

(51) Int. Cl. F26B 5/08

(52) U.S. Cl. 34/312

(57) ABSTRACT

The present invention discloses a spin drying method using a tub (10) provided with a drainage passage, and a drum (20) rotatably positioned in the tub (10), for containing laundry. The spin drying method includes a first step for discharging wash water from the drum (20) to the tub (10) by rotating the drum (20), and a second step for discharging the wash water from the tub (10) to the drainage passage, by reducing a centrifugal force generated in the tub (10) by the rotation of the drum (20).

### TECHNICAL FIELD

The present invention relates to a spin drying method, and more particularly, to a spin drying method which can smoothly discharge wash water flowing from a drum to a tub through a drainage passage, regardless of a centrifugal force of the air generated in the tub by rotation of the drum.

### BACKGROUND ART

In a spin drying process of a washing machine, wash water discharged from a drum is collided with a wall of a tub, dropped by gravity, and discharged through a drainage passage.

The air is forced to flow toward the tub die to a centrifugal force generated in the tub by rotation of the drum. Therefore, the wash water collided with the tub must resist the centrifugal force to be smoothly discharged through the drainage passage.

Meanwhile, the laundry must be evenly distributed in the drum during the spin drying process. However, actually, some of the laundry are gathered to one side by entanglement and the like. That is unbalance of the laundry and the unbalance of the laundry frequently occurs in the spin drying process.

The unbalance of the laundry changes the centrifgal force generated in the tub by the rotation of the drum. Such a change of the centrifugal force interrupts discharge of the wash water through the drainage passage, namely, causes water filling to the tub (water filling phenomenon). A washing method for solving the water filling phenomenon has been disclosed in Korea Laid-Open Patent Gazette 2006-000006.

### DISCLOSURE OF INVENTION

### Technical Problem

An object of the present invention is to provide a spin drying method which can smoothly discharge wash water through a drainage passage in a spin drying process.

Another object of the present invention is to provide a spin drying method which can efficiently conduct spin drying, even if unbalance of laundry occurs in the spin drying process.

### Technical Solution

The present invention provides a spin drying method using a tub provided with a drainage passage, and a drum rotatably positioned in the tub, for containing laundry, the spin drying method including: a first step for discharging wash water from the drum to the tub by rotating the drum; and a second step for discharging the wash water from the tub to the drainage passage, by reducing a centrifugal force generated in the tub by the rotation of the drum.

In one aspect of the present invention, the first step includes a process for rotating the drum at a first rotation speed, and the second step includes a process for decelerating the drum to a second rotation speed lower than the first rotation speed.

In another aspect of the present invention, the spin drying method includes a third step having a process for rotating the drum at a third rotation speed higher than the second rotation speed. For example, the first rotation speed and the third rotation speed may be identical, and the first step and the third step may maintain this rotation speed. However, it is obvious to any one skilled in the art that the present invention is not limited to this condition.

In yet another aspect of the present invention, the spin drying method includes a step for accelerating the drum from the second rotation speed to the third rotation speed prior to the third step.

In yet another aspect of the present invention, at least one of unbalance sensing and preliminary spin drying is conducted prior to the first step. It means that the present invention can be combined with various preliminary and succeeding processes applied to a general spin drying course.

### Advantageous Effects

According to the spin drying method of the present invention, the wash water can be smoothly discharged through the drainage passage in the spin drying process.

According to the spin drying method of the present invention, even if unbalance of the laundry occurs in the spin drying process, the spin drying can be efficiently conducted.

### BRIEF DESCRIPTION OF THE DRAWINGS

FIG. 1 is a drawing illustrating one example of a washing machine capable of conducting a spin drying method in accordance with the present invention;

FIG. 2 is a drawing illustrating one example of a motor sensor for sensing rotation of a drum;

FIG. 3 is a drawing showing one example of a spin drying process in accordance with the present invention; and

FIG. 4 is a drawing showing another example of the spin drying process in accordance with the present invention.

### MODE FOR THE INVENTION

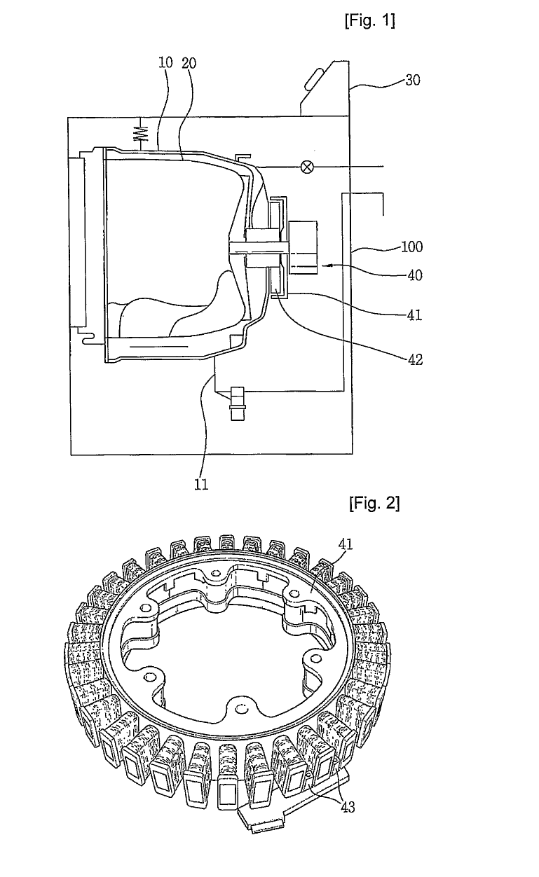

FIG. 1 is a drawing illustrating one example of a washing machine capable of conducting a spin drying method in accordance with the present invention. The washing machine 100 includes a tub 10 for containing wash water, a drum 20 rotatably positioned in the tub 10, for containing laundry, a control unit 30 for controlling the whole washing processes including the rotation of the drum 20, and a motor 40 for rotating the drum 20. The tub 10 includes a drainage passage 11. In the spin drying, the wash water separated from the laundry and discharged from the drum 20 is collided with the tub 10 and drained off through the drainage passage 11. The motor 40 includes a stator 41 and a rotor 42 to rotate the drum 20. The stator 41 has a sensor (for example, a hall sensor) for measuring a rotation momentum of the drum 20. The measured rotation momentum of the drum 20 is transferred to the control unit 30 for use in the control of the washing machine 100. One example of the sensor has been disclosed in Korea Laid-Open Patent Gazette 2005-067914 (refer to FIG. 2). The hall sensor 43 is fitted into the stator 41.

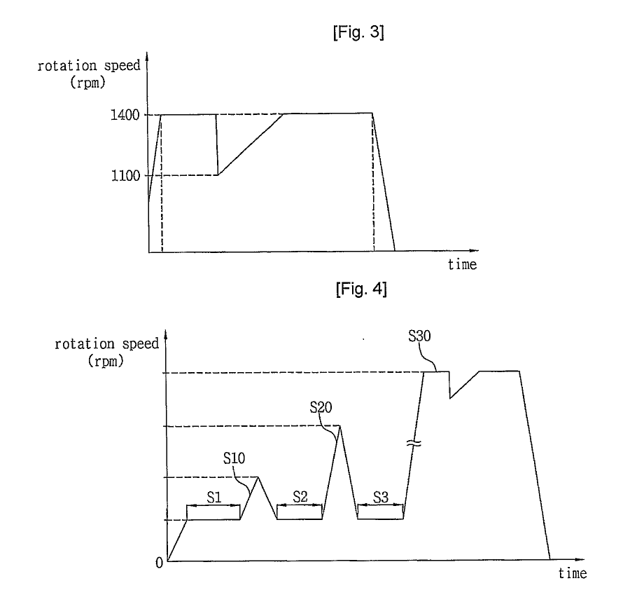

FIG. 3 is a drawing showing one example of a spin drying process in accordance with the present invention. According to a conventional spin drying process, the drum 20 (shown in FIG. 2) is accelerated to maintain the rotation state at a predetermined rotation speed (for example, 1400 rpm) for a predetermined time (for example, 6 min.), for spin drying the laundry. Meanwhile, according to the spin drying process of the present invention, the drum 20 is accelerated to maintain the rotation state at a predetermined rotation speed (for example, 1400 rpm) for a predetermined time (for example, 1 to 2 min.), decelerated (for example, to 1100 rpm), accelerated again (for example, to 1400 rpm), and maintained in this state, for spin drying the laundry. Differently from the conventional art, the present invention reduces a centrifugal force generated in the tub 10 by the rotation of the drum 20, by lowering the rotation speed of the drum 20 in the spin drying process. Accordingly, the wash water in the tub 10 can be smoothly discharged through the drainage passage 11, thereby overcoming the water filling phenomenon. Generally, the washing machine can be designed to prevent the water filling phenomenon. Nevertheless, when unbalance of the laundry occurs in the drum 20 within an allowable range, the centrifugal force increases in the tub 10, to generate the water filling phenomenon. Therefore, the present invention is more efficient to prevent the water filling phenomenon resulting from the unbalance. Moreover, the present invention can provide a design condition for rotating the drum 20 at a higher speed in the same condition washing machine.

FIG. 4 is a drawing showing another example of the spin drying process in accordance with the present invention. Before spin drying (S30) applied with the present invention, unbalance sensing is performed three times (S1, S2 and S3), and preliminary spin drying is performed twice (S10 and S20). It shows that the present invention can be used with various types of spin drying algorithms well known to those skilled in the art.

1. A spin drying method using a tub provided with a drainage passage, and a drum rotatably positioned in the tub, for containing laundry,
the spin drying method comprising:
a first step for discharging wash water from the drum to the tub by rotating the drum; and
a second step for discharging the wash water from the tub to the drainage passage, by reducing a centrifugal force generated in the tub by the rotation of the drum.

2. The spin drying method of claim 1,
wherein the first step includes a process for rotating the drum at a first rotation speed, and the second step includes a process for decelerating the drum to a second rotation speed lower than the first rotation speed.

3. The spin drying method of claim 2,
comprising a third step including a process for rotating the drum at a third rotation speed higher than the second rotation speed.

4. The spin drying method of claim 3,
comprising a step for accelerating the drum from the second rotation speed to the third rotation speed prior to the third step.

5. The spin drying method of claim 2,
comprising an acceleration step for accelerating the drum from the second rotation speed to a third rotation speed higher than the second rotation speed.

6. The spin drying method of any one of claims 1 to 5,
comprising a preliminary step for conducting at least one of unbalance sensing and preliminary spin drying prior to the first step.
